(19) United States
(12) Patent Application Publication
(10) Pub. No.: US 2022/0040777 A1
(43) Pub. Date: Feb. 10, 2022

(54) WELDING SYSTEM WITH BREATH-BASED CONTROL

(71) Applicant: Roodmax LLC, Los Angles, CA (US)

(72) Inventors: David Michael Max, Shadow Hills, CA (US); Daniel James Reetz, Sherman Oaks, CA (US); Gary Fenno Knowlton, La Crescenta, CA (US)

(21) Appl. No.: 16/987,976

(22) Filed: Aug. 7, 2020

(51) Int. Cl. B23K 9/095; B23K 9/09; B23K 9/32

(52) U.S. Cl. CPC B23K 9/0953; B23K 9/32; B23K 9/09; B23K 9/0956

(57) ABSTRACT

A new welding system is provided that makes use of breath of the operator to control one or more operating parameters of the power source or welding machine (or “welder”). The welding system may be configured for arc welding, and the welding machine or welder may include a constant voltage power source with varying current (or vice versa). In such an embodiment, the welding system includes a breath-based controller with a mouthpiece through which the operator can breathe or blow in air. The breath-based controller processes the user's breath to determine user input, and this operator input is communicated to the welder or welding machine (via wired or wireless communication links) to control arc intensity (i.e., current for a constant voltage welding machine) or arc length (i.e., voltage for a constant current welding machine). An operator uses the breath-based controller to remotely control the welding machine with high precision.

### BACKGROUND

### 1. Field of the Description

The present invention relates, in general, to manual welding systems, and, more particularly, to a welding system configured to provide breath-based control over welding intensity (which may be measured in some cases by current levels (or amperage)) provided by the welding machine or welder so as to eliminate the need for a foot pedal controller.

### 2. Relevant Background

There are numerous uses of welding in the manufacturing, building, and repair industries. Often, due to the setting or work environment, the welding is more effectively performed manually rather than in an automated manner. Manual welding operations can be very time consuming to perform due to the need to set up the welding system for onsite work in many cases, and the effectiveness and quality of the resulting weld is very dependent upon the skill and experience of the operator of the welding machine (or “welder”). Hence, there remains a demand for devices and components that facilitate the welding process including improved controllers for the welder (or welding system's power source or machine).

In brief, welding is a fabrication process that joins materials, usually metals or thermoplastics, by using high heat to melt the parts together and allowing them to cool, causing fusion. In addition to melting the base metal, a filler material is typically added to the joint to form a pool of molten material (the weld pool) that cools to form a joint that, based on weld configuration (butt, full penetration, fillet, and so on), can be stronger than the base material. Many different energy sources can be used for welding including an electric arc (electrical), a laser, an electron beam, friction, and ultrasound. A welder or welding machine is included in each welding system to act as the energy source and to control welding intensity. For example, the electrical power necessary for arc welding processes, a variety of different power supplies or “welders” can be used. The most common welding power supplies are constant voltage power supplies that hold the voltage constant and vary the current. In arc welding, the length of the arc is directly related to the voltage, and the amount of heat input (or “intensity”) is related to the current.

Presently, manual welding processes require an operator (also known as a “welder”) to control the welding intensity (i.e., current in the case of arc welding) by providing operating input or to interact physically with a controller. In many welding systems, the operator manipulates a foot pedal controller, which is remote from the welder or welding machine, to vary the welding intensity. As the pedal is depressed by the operator's foot, the intensity of the weld arc is increased (e.g., the amperage of the current is increase in arc or TIG/stick welding).

While foot pedal controllers have been used for many years, there is a demand in the welding industry for improvements to address the disadvantages with these pedal controllers. Foot pedal controllers are typically quite large in size and weight (e.g., similar to two building bricks), and they are not convenient to use in many environments such as when the welder needs to reach into hard-to-reach spaces or cannot remain in a standing position during the weld process. Welding is often performed from a seated position, which may result in the pedal controller being in an inconvenient place relative to the seated welder. Even in many standing welding operations it can be impractical or even impossible for the welder to operate the pedal controller, e.g., when standing on a building ledge and having to use a foot needed for proper balance to operate the pedal controller. In nearly all applications, conventional foot pedal controllers can make weld set-up more complicated and time consuming as a welder may spend up to an hour setting up a single weld. One of the ways foot pedal controllers make setup difficult is the cable that connects the pedal to welding machine because it may be too long or short or it may be difficult to get into position or become tangled.

### SUMMARY

The present invention addresses the above problems with foot pedal controllers. A new welding system is provided that makes use of breath of the operator to control one or more operating parameters of the power source or welding machine (or “welder”). For example, the welding system may be configured for arc welding, and the welding machine or welder may include a constant voltage power source with varying current (or vice versa). In such an embodiment, the welding system includes a breath-based controller with a mouthpiece through which the operator can breathe or blow in air from their lungs. The breath-based controller processes this operator input (or user's breath) to determine operator or user input, and this operator input is communicated to the welder or welding machine (via wired or wireless communication links) to control arc intensity (i.e., current for a constant voltage welding machine) or arc length (i.e., voltage for a welding machine). In this manner, an operator (or welder) is able to use the breath-based controller to remotely control the welding machine with high precision and versatility.

More particularly, a welding system is provided that is adapted for breath-based control. The system includes a welding machine or welder (e.g., an arc welder). The system also includes a breath-based controller that is spaced apart from and communicatively linked to the welding machine. The controller includes an output interface transmitting control signals (e.g., in a wired or wireless manner) to the welding machine to define a value of at least one operating parameter of the welding machine during operations of the welding system. The controller also includes a mouthpiece assembly adapted to receive breath of an operator of the welding system. Further, the controller includes a sensor sensing a pressure based on the breath in the mouthpiece assembly and a processor processing the pressure sensed by the sensor and, in response, generating the control signals to adjust operations of the welding machine.

In some embodiments, the operating parameter is the welding intensity generated by the welding machine. For example, the welding machine may be adapted for arc welding, and the at least one operating parameter sets a current or voltage level for the welding machine so as to define the arc's intensity. In the same or other embodiments, the processor runs a mapping module to map a magnitude of the pressure sensed by the sensor to a value of the at least one operating parameter falling within a predefined range for the welding machine. In such cases, the sensor may be adapted to have a sensitivity range falling in the range of 0 to 1.5 pounds per square inch (PSI) when measuring exhaling or output air and −1.5 to 0 PSI when measuring inhaling or sucking in air from the sensor assembly (or that which can typically be provided by a human operator). The sensitivity range can then be mapped using the mapping module in a linearized manner or with a non-linear fit to the predefined range for the at least one operating parameter. The control signals can be generated by the processor based on the pressure sensed by the sensor to cause the welding machine to provide a stepped output or a pulsed output.

In some implementations of the welding system, the mouthpiece assembly includes an upper segment with an inlet member and a hollow body defining a chamber for receiving the breath that passes through a channel in the inlet member. The assembly may further include a lower segment with a hollow body defining a chamber for receiving a volume of fluid. Then, a membrane, formed of a resilient material, may be included that separates the chamber of the upper segment from the chamber of the lower segment. Further, the lower segment may include an outlet member providing a channel to fluidically couple the chamber of the lower segment with the sensor, whereby the sensor senses the pressure as a change in a pressure of the fluid based on elastic deformation of the membrane by the breath of the user/operator of the welding machine.

### BRIEF DESCRIPTION OF THE DRAWINGS

FIG. 1 is a functional block or schematic drawing of a welding system adapted to implement breath-based control of the present description and using wired communications;

FIG. 2 is a functional block or schematic drawing of a welding system adapted to implement breath-based control similar to that of FIG. 1 but using wireless communications;

FIG. 3 is a perspective cross-sectional view of a controller mouthpiece assembly of the present description as may be used to implement the mouthpiece shown in the welding systems of FIGS. 1 and 2;

FIG. 4 illustrates one implementation of the controller mouthpiece assembly of FIG. 3 showing the components during assembly;

FIG. 5 illustrates the lower or sensor-mating segment of the mouthpiece assembly of FIGS. 3 and 4 after attachment of a chamber separation element or membrane;

FIG. 6 illustrates the controller mouthpiece assembly of FIGS. 3-5 after assembly is completed;

FIG. 7 illustrates the mouthpiece assembly of FIGS. 3-6 after connection with a pressure sensor;

FIG. 8 illustrates another embodiment of a mouthpiece assembly connected to a pressure sensor in a manner similar to that of FIG. 7;

FIG. 9 illustrates the mouthpiece assembly of FIG. 8 further modified to include an upstream input component or mouthpiece;

FIG. 10 illustrates the mouthpiece assembly of FIGS. 3-6 in a configuration similar to that of FIG. 7 with the addition of drainage components;

FIG. 11 illustrates a mouthpiece assembly adapted for providing boosting or amplification of input breath upstream of a sensor inlet or sensing surface; and

FIGS. 12A-12C illustrate mapping processes that may be carried out by a breath-based controller of the present description to map input breath to a controlled parameter of a welding machine.

### DETAILED DESCRIPTION

Embodiments described herein are directed to a welding system that is configured to provide breath-based control over the system's welder or welding machine (also known as the power source). In one exemplary embodiment, the system includes a breath-based controller, and a user or operator of the system blows into a mouthpiece of this controller. The controller reacts to the amount of input air or breath (or a pressure created due to its input into the mouthpiece) to vary or control one or more parameters of the system's welding machine or welder. The controlled parameters for the welding machine may be chosen to control the intensity of the weld provided at a particular time during operations of the welding system. For example, the welding machine may be configured with a power source for arc welding and the breath-based controller may map sensed breath or air input from the operator to a range of current (or voltage) to control the intensity of the arc. Other controlled parameters may include pulse length. The mapping provided by the breath-based controller to the parameter may be quantized so as to make it easier for an operator/welder to have that parameter's value land within a desirable range.

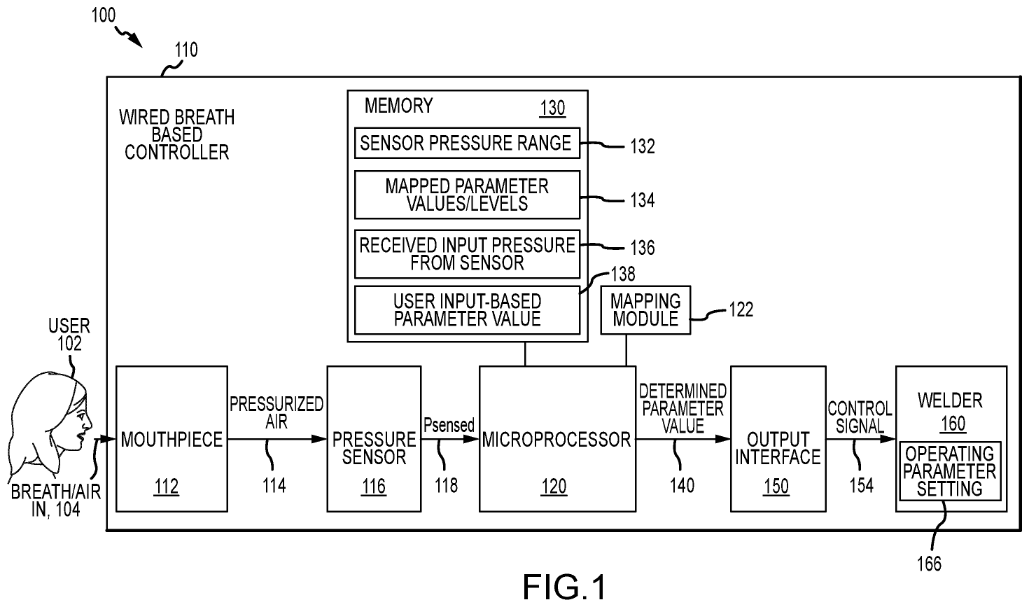

FIG. 1 illustrates a schematic diagram of a welding system 100 of the present description adapted, via wired signal or data transmissions, to enable an operator or user to control welding using their breath instead of having to use a foot pedal controller or the like. As shown, the system 100 includes a breath-based controller 110 and a welder/welding machine 160, and, during operations of the system 100, the controller 110 transmits control signals as shown with arrow 154 to the machine 160 to adjust or set one or more operating parameters of the welder/welding machine 160 as shown at 166.

The controller 110 includes a mouthpiece or mouthpiece assembly 112 that is adapted to facilitate a user/operator 102 to provide user input 104 in the form of air or their breath (during exhale or inhale or both). This produces changes in the pressure of air in the mouthpiece as shown at 114 with “pressurized air,” and the controller 110 includes one or more pressure sensors 116 that are in or adjacent to an inner chamber(s) of the mouthpiece 112, whereby the sensor 116 operates to provide/output a sensed or measured pressure as shown at 118 (or to provide a signal that may be converted into a pressure reading or value).

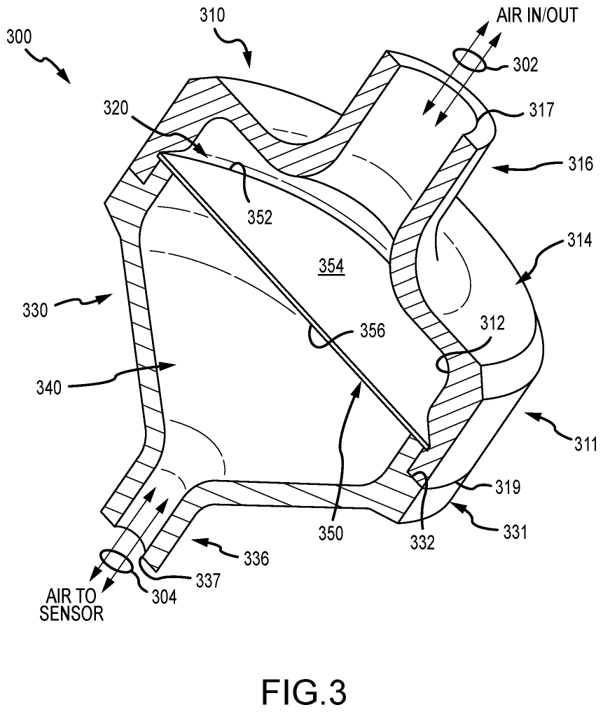

The pressure sensor 116 may take a wide variety of forms to practice the controller 110 such as an analog sensor or a digital sensor. Its connection to the user 102 and their breath 104 may be open (directly sense breath in (exhale) or out (inhale) 104) or closed (indirectly sense changes in pressure caused by input or output of breath 104 as shown below for the mouthpiece assembly in FIGS. 3-6). The pressure sensor 116 may be chosen to have an operating range suited to values of pressure that may be readily created by a human user 102 or with human lung pressures, e.g., a sensor with a range of 0 to 1.5 PSI (upon exhale), −1.5 to 0 PSI (upon inhale) or the like) so as to provide more accurate and/or precise mapping of sensed pressures 118 to operating parameter settings 166 of a welding machine/welder 160.

The breath-based controller 110 further includes a microprocessor 120 for processing the sensed pressure 118 and generating a determined parameter value 140. The controller 110 further includes an output interface 150 to convert this into a control signal transmitted in a wired manner as shown with arrow 154 to a control signal input of the welder 160 for use (by this input or the machine's onboard controller) in controlling or adjusting the operating parameter setting 166. The output interface/circuit 150 may take the form of an operational amplifier (op-amp)-type circuit, a pulse width modulation (PWM) chopper or circuit, a metal-oxide-semiconductor field-effect transistor (MOSFET) switching output, a light dependent resistor (LDR)-based optical interface, a voltage divider, or other useful output interface design. The functionality of the microprocessor 120 may be implemented to be wholly or partially analog or the microprocessor 120 may be a digital processor or computing device operable to process the output 118 (analog or digital) of the pressure sensor 116. When digital, the processor 120 may operate to run software and/or execute code to provide the functions of a mapping module 122 as well as managing the memory/data storage 130 (or such functions can be partially or wholly replaced with analog components).

As shown, the memory 130 is used to store a pressure range 132 for the sensor 116 in which the sensed pressure 118 will fall. Further, the memory 130 is used to store a set of parameter values or levels 134 that may be controlled (e.g., parameter settings 166) on the welder 160. For example, an amperage range or voltage range may be provided for controlling the operating parameter settings 166 of the welder when the welder is an arc-type welding machine. These mapped or mappable parameter values or levels 134 may start at zero or may start at a default value as the input pressure 118 may be used to increase (with positive pressure or change in pressure during exhale) or decrease (with negative pressure or change in pressure during inhale) the parameter setting from a minimum default value up to a maximum value/setting for the operating parameter (e.g., a maximum welding intensity or the like). Note, the sensed pressure 118 may be a positive or negative change in pressure of air in a chamber of the mouthpiece 112 associated with blowing air in or sucking air out, respectively, as shown at 104.

During operations, the microprocessor receives pressure readings 118 from the pressure sensor 116 and stores these in memory 130 as shown at 136. Then, the mapping module 122 acts to map these pressure inputs 136 to user input-based parameter values 138, which are output at 140 to the output interface 150 for transmittal as control signals 154 for the welder 160. For example, the mapping function/module 122 may linearize the input 136 within the desired range of a parameter value 134 (such as an arc intensity within an acceptable range (e.g., a particular current level for a variable current arc welder 160)) so as to generate a user input-based parameter value 138.

The function or algorithm implemented by the mapping module 122 may also be configured to make a non-linear fit of input pressure 136 to the parameter value range 134 (e.g., range of welding intensities) to ease or facilitate control. In some cases, the mapping module 122 may, as discussed above, vary the parameter setting 166 with values 140 so as to modify a default or standard operating value (e.g., a minimum current or voltage during operations of the welder 160) or to provide a stepped output or a pulsed output to suit a type of machine 160 and/or to suit a particular input desired by the operator 102 (and such input mapping may be selectable on the controller, e.g., linear, non-linear fit, stepped, pulsed, and so on). In some embodiments, the sensed pressure or measured user input 118 is used to change the parameter setting 166 on an ongoing basis (e.g., zero or a default value when not blowing or sucking air 104) or on an intermittent basis (e.g., to step up or down the present value of the operating parameter setting 166 by providing user input 104 and retaining this value until a next input 104 is sensed by the sensor 116).

In some embodiments of system 100, a booster component is provided in the mouthpiece 112 or elsewhere upstream of the sensing surface of the pressure sensor 116. The booster component functions to change, e.g., magnify or amplify, the pressure 114 to the sensor 116 (such as by a multiplier of 1.5 to 5 or more) to enhance the sensing ability and/or range of the sensor 116. It may be configured also or instead to filter or block moisture in the breath 104 from reaching the surfaces of the sensor 116. It may be configured with a quick disconnect coupling to the sensor 116 and/or to the mouthpiece body to facilitate cleaning, replacement, or repair.

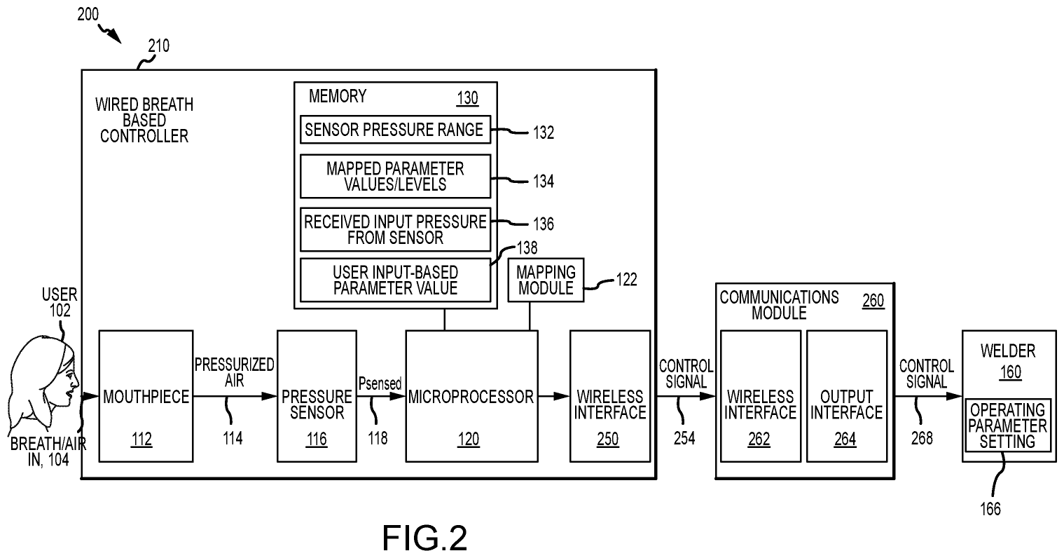

FIG. 2 illustrates a welding system 200 with many components found in system 100 of FIG. 1 but configured for wireless communications between the controller 210 and the welder 160. Like features/components are given like reference numbers, and their functions are not discussed in detail again as they will be understood from the discussion of system 100 of FIG. 1. To provide wireless communications, the breath-based controller 210 is shown to include a wireless interface 250 in place of the output interface 150, and this interface 250 outputs the control signal in wireless form as shown at 254. It is received by a communications module 260 of the welder 160, with its wireless interface 262 and output interface 264 for providing the control signal 268 in a form similar to that provided at 154 by output interface 150. The output interface 250 may take a wide variety of forms to provide a wireless communication link such as a wireless connectivity module, e.g., a 2.4 GHz link such as that distributed by Digi XBee or the like.

As noted above, the mouthpiece may be implemented in a variety of ways to direct the input air or breath to a sensor for sensing breath-based user input. However, it may be useful at this point to describe one useful design of a mouthpiece assembly 300 with reference to FIGS. 3-6 that may be used for the mouthpiece 112 of systems 100 and 200 of FIGS. 1 and 2.

FIG. 3 is a perspective cross-sectional view of a controller mouthpiece assembly 300, which may be considered a “closed” design as it separates the sensor's sensing surface from the input air/breath. In this regard, the assembly 300 includes an air-inlet or upper segment 310, a sensor-mating or lower segment 330, and a chamber-separation element or membrane 350 disposed between the two segments 310 and 330. Both segments 310 and 330 have hollow, cylindrically-shaped bodies 311 and 331 that define, respectively, a breath input chamber 320 and sensor-exposed chamber 340, which contain a volume of air (or other gas) that is exposed to a sensing surface of the pressure sensor (not shown in FIG. 3) of a breath-based controller as shown by arrows 304 showing air flowing to a sensor. The two segments 310, 330 may be formed of a hard and rigid plastic or other material or may be formed of an airtight rubber or softer plastic in some cases for comfort of the user/operator of the controller. The volume of the two chambers 320 and 340 typically are relatively small to allow a user/operator to readily fill and pressurize the breath input chamber 320, e.g., 10 to 50 cubic centimeters (cc's) or more.

The upper or inlet segment 310 has a body 311 with an outer diameter (e.g., 1 to 3 inches) that along with the wall thickness and height (e.g., 0.25 to 1.5 inches) defines the breath input chamber 350. A tubular inlet member 316 extends outward from the body 311 (with a length of 0.25 to 1 or more inches) to an opening/inlet 317 so as to define a channel or tubular passage for input air to be blown into the chamber 320 (and for it to exit, too, when suction is applied for a negative pressure or upon an inhale by the user/operator) as shown with arrows 302. The upper side wall 314 of the body 311 encloses the chamber 320 and mates in an airtight manner to the inlet member 316, and its exterior surface may be recessed or take another shape to better fit and/or receive an operator's lips during use of the assembly 300. While not shown in FIG. 3, the upper or inlet segment 310 typically will include in the body 311 a leakage hole to allow an outflow of air during use of the mouthpiece assembly 300.

The sensor-mating or lower segment 330 also includes a hollow, cylindrically-shaped body 331 with an outer diameter matching that of the body 311. The segment 330 may be funnel shaped as shown with the body 331 extending in a sloped manner to a smaller diameter tubular outlet member 336, with an open outlet 337 that may be mated or coupled with a sensor inlet member (not shown). The two segments are mated together (such as with an adhesive or the like) at the wall surfaces/sides 319 and 332, which may be shaped in a variety of ways to achieve a strong and airtight seal such as to provide the S (or Z)-shaped joint shown. The chamber-separation element or membrane 350 is disposed between the two segments 310 and 330, and its outer edges may be affixed (with an adhesive or the like) to either of the surfaces/sides 319 and 332 prior to mating the two segments 310 and 330 together, with it being attached to the lower segment 330 in the embodiment of FIG. 3.

The membrane 350 includes a first side 354 facing into the inlet chamber 320 and a second side 356 facing into the sensor-facing chamber 340. The membrane 350 is typically formed so as to be capable of elastic deformation. For example, the membrane 350 may be formed from a thin sheet of an elastic material such as a rubber or reinforced rubber (for durability), and the membrane 350 may be drawn relatively taut across the opening to the chamber 340 defined by the wall surface/side 332. Then, in use, air 302 filling the chamber 320 to a pressure greater (or lower) than that of the air 304 in the chamber 340 may cause the membrane 350 to elastically flex into the chamber 340 (or into the chamber 320 during inhaling or sucking), and the pressure or changes in pressure of air 304 exposed to the sensor may be sensed by the controller's sensor.

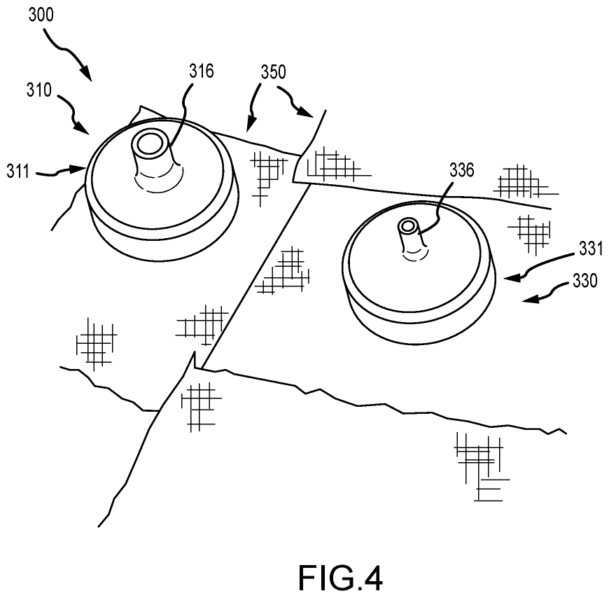

FIG. 4 illustrates the controller mouthpiece assembly 300 of FIG. 3 during assembly. As shown, the two segments 310 and 330 may be formed as separate parts such as using a molding process with a plastic fill material. The membrane 350 may be provided as a flattened sheet of a flexible material. FIG. 4 is also useful for showing the inlet and outlet members 316 and 336 of the mouthpiece assembly 300 in further detail with fluid flow openings to allow a user to use their breath to provide an input and for a sensor to be exposed to air or other fluid inside the segment 330.

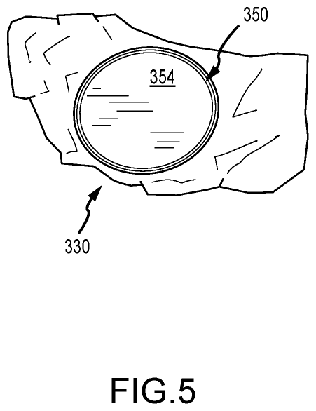

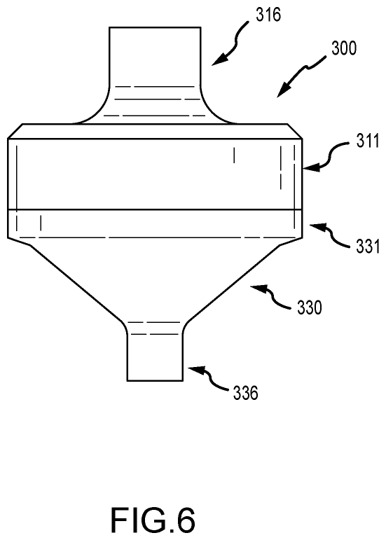

FIG. 5 illustrates the lower or sensor-mating segment 330 of the mouthpiece assembly 300 of FIG. 3 upon attachment of a chamber separation element or membrane 350. As shown, the membrane 350 is stretched to be taut or at least substantially planar as it is applied, e.g., via an adhesive, to the side or exterior surface 332 of the body 331 of the lower segment 330. FIG. 6 illustrates the controller mouthpiece assembly 300 of FIGS. 3-5 after assembly is completed and before the outlet member 336 is coupled to a pressure sensor such as via a section of flexible tubing or the like to allow the mouthpiece assembly 300 to be handheld during use by the operator some distance away from other components of the controller.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

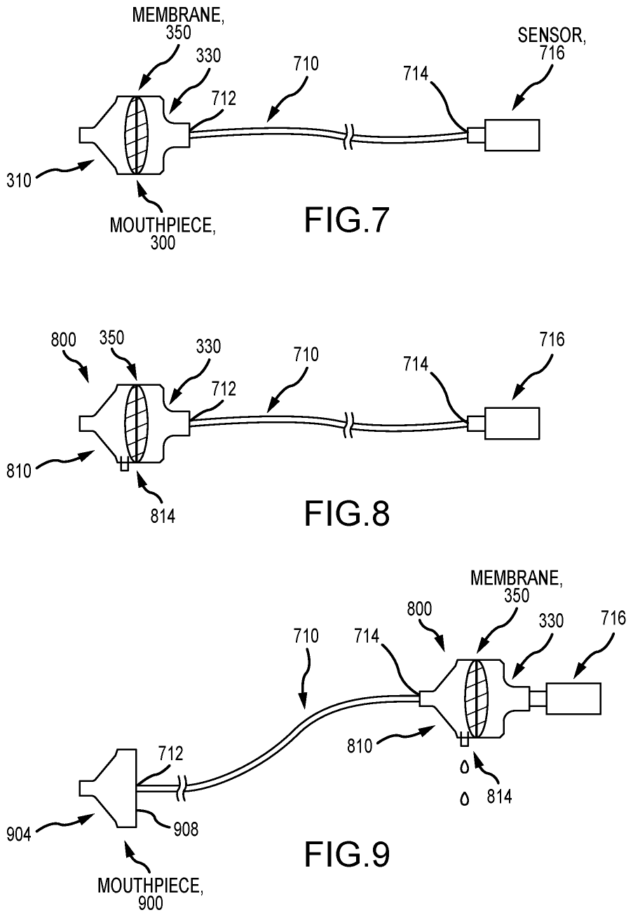

For example, there are a variety of ways that a mouthpiece assembly of the new system may be attached to a pressure sensor, may be configured to receive breath and/or to provide drainage of condensate in a user's breath, and/or may be adapted to achieve pressure sensing in a more efficient and accurate manner. FIG. 7 illustrates the mouthpiece assembly 300 of FIGS. 3-6 after connection with a pressure sensor 716. This illustrated configuration involves use of a length (e.g., 1 to 6 feet or more) of tubing 710, which is fluidically coupled at a first end 712 to the outlet 336 of the lower or outlet segment 330 of the mouthpiece assembly and at a second end 714 to the inlet of the sensor 716. In such a configuration, the sensor 716 is sensing the change of pressure of air or other fluid in the chamber 340 of lower or outlet segment 330 as well as in the tubing 710.

FIG. 8 illustrates another embodiment of a mouthpiece assembly 800 connected to a pressure sensor 716 in a manner similar to that of FIG. 7, e.g., via connecting tubing 710 as shown. The assembly 800 may be considered a blow-through configuration as an upper or inlet segment 810 is provided that includes in its body an orifice or blow-through outlet 814 that is adapted to allow a steady flow of air/breath from a welder/user of the assembly 800 to flow over the membrane 350 and out of the segment's inner chamber. The orifice/outlet 814 may have a relatively small diameter (e.g., 0.5 to 1 mm or more) to cause pressure to build up while providing an outlet for breath and/or any collected condensate or moisture in the user's breath. Testing has shown that by allowing a small amount of air to constantly be discharged or to “leak” (blow-through) allows for easier and more consistent pressure (or breath-based) control over a welding machine.

FIG. 9 illustrates the mouthpiece assembly 800 of FIG. 8 connected more directly (e.g., via a direct coupling as shown between the lower segment 330 and the inlet to the sensor 716). Further, though, the inlet of the upper or inlet segment 810 may be coupled to the second or outlet end 714 of the connecting tubing 710 while the first or inlet end 712 is coupled to an outlet/backwall 908 of a mouthpiece 900. The mouthpiece 900 includes an inlet 904 in its body for receiving a user's breath upon exhale (or having air sucked out during inhale). During use, the assembly 800 is spaced apart from the mouthpiece 900 and user by the length of the tubing 710 and the orifice or blow-through hole 814 acts as a remote drain for condensate or moisture from the mouthpiece 900 and tubing 710, which can improve the effectiveness of the sensor 716 in sensing user input via pressure changes in the chamber of the lower or outlet segment 330. Moving the condensate drain to a “cooler” side of the system (e.g., not pressed against human flesh) may be desirable in some applications.

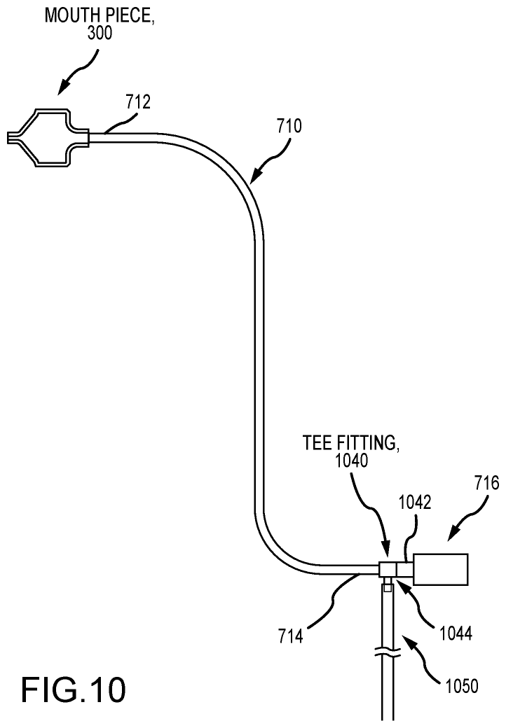

FIG. 10 illustrates a configuration in which the mouthpiece assembly 300 of FIGS. 3-6 (with the membrane 350 removed) coupled to the sensor 716 similar to the arrangement of FIG. 7 but with the addition of drainage. The drainage is provided in this case by coupling the outlet or second end 714 of the tubing 710 to an inlet (or first opening) of a tee fitting 1040, which has one outlet (or second opening) coupled via tubing/connector 1042 to an inlet of the sensor 716 and has another outlet (or third opening) coupled via connector 1044 to an inlet of a drain hose 1050 (which may have a relatively small ID such as 0.5 to 1 mm or the like) to provide drainage of liquid in the tubing 710 while allowing accurate pressure sensing in the tubing 710. The use of the tee fitting 1040 is useful for draining off condensate and spit before it hits the sensor 716 and it allows a small amount of air to blow-through or leak, which permits easier pressure control.

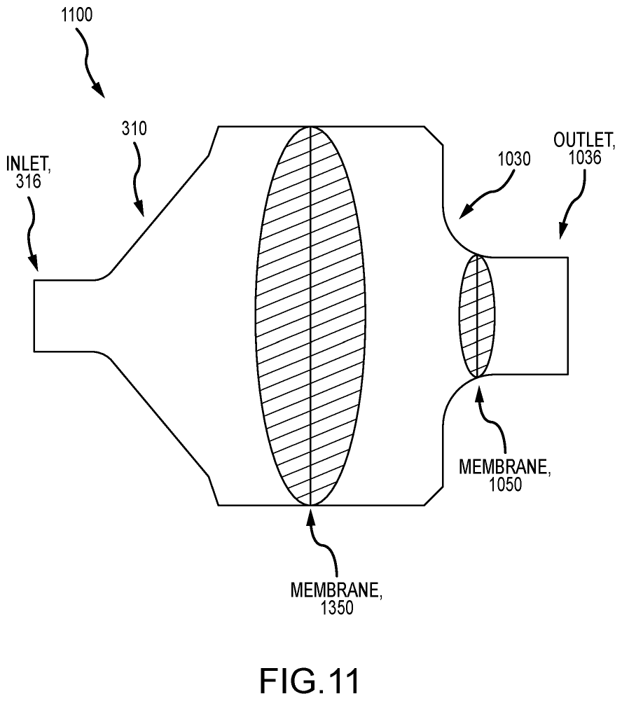

In some cases, it may be useful to boost or amplify the change in pressure created by a user's input (or sucked out) breath in a mouthpiece to make a sensor more effective (or allow a less expensive sensor to be used) in measuring pressure change. FIG. 11 illustrates a mouthpiece assembly 1100 adapted for providing boosting or amplification of input breath upstream of a sensor inlet or sensing surface. The assembly 1100 includes the upper or inlet segment 310 of the assembly 300 of FIG. 3 with its body including an inlet 316 to receive user's breath during use into an inner chamber, and the membrane (or first membrane) 350 is provided at the outlet of the body of the upper or inlet segment 310.

The assembly 1100 further includes a lower or outlet segment 1030 coupled to the lower or inlet segment 310 (as discussed for assembly 300 of FIG. 3). The segment 1030 has a body with an outlet 1036 that can be fluidically coupled to an inlet of a pressure sensor (as discussed above with reference to FIGS. 7-10), and the body of the segment 1030 is configured to receive a second or booster membrane 1050 upstream of the outlet 1036 (or at or near the inlet to the outlet member 1036). The second membrane 1050 extends across the outlet 1036 to define a space or chamber in the body of the segment 1030 between the membranes 350 and 1050 such that deformation of the membrane 350 causes fluid (e.g., air) trapped between the two membranes 350 and 1050 to have its pressure changed causing deformation of second membrane 1050 and a change in pressure downstream of the membrane 1050 (e.g., in a tubing coupled to the outlet 1036 and to a sensor inlet). The second membrane 1050 is configured to be smaller than the first membrane 350 to create a boosting effect such as with a diameter that is ¾ to ¼ (or smaller) of that of the first membrane 350. The desired boosting effect can be achieved by selection of the sizes of the two membranes 350, 1050, e.g., if the first membrane 350 has two times the area of the second membrane 1050 the pressure is doubled from inlet 316 to outlet 1036 of the mouthpiece assembly 1100.

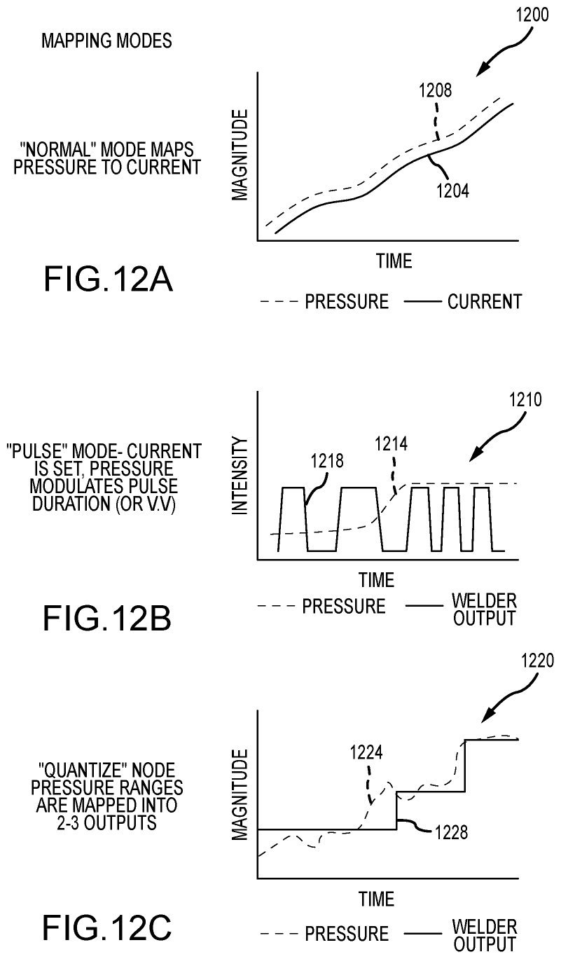

FIGS. 12A-12C illustrate mapping processes that may be carried out by a breath-based controller of the present description to map input breath to a controlled parameter of a welding machine, e.g., by mapping module 122 of controller 110 of FIG. 1 to control operating parameter settings 166 of welding machine 160. FIG. 12A illustrates a mapping process with graph 1200 that can be used to map sensed or input pressure 1208 to an intensity of a weld by varying magnitude of current over time as shown with line 1204. Here the mapping is shown to be linear but it may also be non-linear in some cases.

FIG. 12B illustrates another mapping process with graph 1210. In this case, the parameter (e.g., current of the welding machine) is set or fixed, and the mapping module of the breath-based controller acts to use sensed pressure 1214 to modulate pulse duration (or to vary voltage) over time, with welding output shown with line 1218. In this way, the breath-based control can be used to change pulse length or any of the other pulse parameters of a welding machine instead of only intensity. FIG. 12C illustrates another mapping process with graph 1220. In this embodiment, the input or sensed pressure 1224 (or ranges of such pressure) are mapped into two, three, or more welder outputs (or control parameters for a welding machine) as shown with line 1228. This embodiment may be considered a controller operating in “quantize” mode to take ranges of input and force them into fixed levels of output. For example, a welder may be set to one fixed low output if giving low inputs of various values, and the same for ranges of medium and high inputs/pressures so as to account for “wobbly” or time-varying breath inputs.

In practice, the breath-based controller may be configured to allow a user or welder to select which of two, three, or more mapping modes to use during a particular welding session, with three different mapping modes shown as an illustration but not as a limitation to the number and types of mapping that may be used between the user input (breath) and a control parameter for a welding machine.

We claim:

1. A controller adapted for breath-based control of welding, comprising:
an output interface transmitting control signals to a welding machine to define a value of at least one operating parameter of the welding machine during operations of welding machine;
a mouthpiece assembly adapted to receive breath of an operator of the welding machine;
a sensor sensing a pressure based on the breath in the mouthpiece assembly; and
a processor processing the pressure sensed by the sensor and, in response, generating the control signals.

2. The controller of claim 1, wherein the at least one operating parameter is welding intensity generated by the welding machine.

3. The controller of claim 2, wherein the welding machine is adapted for arc welding and wherein the at least one operating parameter sets a current or voltage level for the welding machine.

4. The controller of claim 1, wherein the processor runs a mapping module to map a magnitude of the pressure sensed by the sensor to a value of the at least one operating parameter falling within a predefined range for the welding machine.

5. The controller of claim 4, wherein the sensor is adapted to have sensitivity range falling in the range of 0 to 1.5 pounds per square inch (PSI) and wherein the sensitivity range is mapped in a linearized manner or with a non-linear fit to the predefined range for the at least one operating parameter.

6. The controller of claim 1, wherein the control signals are generated by the processor based on the pressure sensed by the sensor to cause the welding machine to provide a stepped output or a pulsed output.

7. The controller of claim 1, wherein the mouthpiece assembly comprises an upper segment with an inlet member and a hollow body defining a chamber for receiving the breath that passes through a channel in the inlet member, wherein the mouthpiece assembly further comprises a lower segment with a hollow body defining a chamber for receiving a volume of fluid, wherein the mouthpiece assembly further comprises a membrane formed of a resilient material separating the chamber of the upper segment from the chamber of the lower segment, and wherein the lower segment includes an outlet member providing a channel to fluidically couple the chamber of the lower segment with the sensor, whereby the sensor senses the pressure as a change in a pressure of the fluid based on elastic deformation of the membrane by the breath.

8. A welding system adapted for breath-based control, comprising:
a welder with an energy source; and
a breath-based controller communicatively linked in a wired or wireless manner to the welding machine, the breath-based controller including:
an output interface transmitting a control signal to the welder to adjust an operating parameter of the energy source during operations of the welding system;
a mouthpiece assembly with an inlet member for receiving breath of an operator of the welding system and with a channel providing a tubular passage to an inner chamber;
a sensor sensing pressure of the breath in the inner chamber and outputting a pressure signal; and
a digital or analog processor generating the control signal based on the pressure signal.

9. The system of claim 8, wherein the welder is an arc welder and wherein the operating parameter is a current level or a voltage level for the energy source, whereby a welding intensity of the welder is controlled by the breath-based controller.

10. The system of claim 8, wherein the processor is digital and executes code to map the pressure sensed by the sensor to a value of the operating parameter of the energy source.

11. The system of claim 10, wherein the sensor is adapted to have sensitivity range falling in the range of 0 to 1.5 pounds per square inch (PSI) and wherein the sensitivity range is mapped in a linearized manner or with a non-linear fit to a predefined range for the operating parameter.

12. The system of claim 8, wherein the control signal is generated by the processor based on the pressure sensed by the sensor to cause the energy source to provide a stepped output or a pulsed output.

13. The system of claim 8, wherein the mouthpiece assembly comprises an upper segment with the inlet member and a hollow body defining the chamber for receiving the breath that passes through a channel in the inlet member, wherein the mouthpiece assembly further comprises a lower segment with a hollow body defining a chamber for receiving a volume of fluid, wherein the mouthpiece assembly further comprises a membrane adapted for elastic deformation separating the chamber of the upper segment from the chamber of the lower segment, and wherein the lower segment includes an outlet member providing a channel to fluidically couple the chamber of the lower segment with the sensor, whereby the sensor senses the pressure as a change in a pressure of the fluid.

14. A controller adapted for breath-based control of welding, comprising:
an output interface transmitting control signals in a wired or wireless manner to a welding machine to define a value of an operating parameter of an energy source of the welding machine;
an inlet member for receiving breath of an operator of the welding system and with a channel providing a tubular passage to an inner chamber;
a sensor sensing pressure of the breath in the inner chamber and outputting a pressure signal; and
a digital or analog processor generating the control signal based on the pressure signal.

15. The system of claim 14, wherein the mouthpiece assembly comprises an upper segment with the inlet member and a hollow body defining the chamber for receiving the breath that passes through a channel in the inlet member, wherein the mouthpiece assembly further comprises a lower segment with a hollow body defining a chamber for receiving a volume of fluid, wherein the mouthpiece assembly further comprises a membrane adapted for elastic deformation separating the chamber of the upper segment from the chamber of the lower segment, and wherein the lower segment includes an outlet member providing a channel to fluidically couple the chamber of the lower segment with the sensor, whereby the sensor senses the pressure as a change in a pressure of the fluid.

16. The system of claim 14, wherein the processor is digital and operates to map the pressure sensed by the sensor to a value of the operating parameter of the energy source.

17. The system of claim 16, wherein the sensor is adapted to have sensitivity range falling in the range of 0 to 1.5 pounds per square inch (PSI) and

18. The system of claim 17, wherein the sensitivity range is mapped in a linearized manner or with a non-linear fit to a predefined range for the operating parameter.

19. The system of claim 14, wherein the welder is an arc welder and wherein the operating parameter is a current level or a voltage level for the energy source, whereby a welding intensity of the welder is controlled by the breath-based controller.

20. The system of claim 14, wherein the control signal is generated by the processor based on the pressure sensed by the sensor to cause the energy source to provide a stepped output or a pulsed output.
